(19) United States
(12) Patent Application Publication
(10) Pub. No.: US 2026/0205037 A1
(43) Pub. Date: Jul. 16, 2026

(54) MOTOR DRIVER HAVING MOTOR ROTATIONAL DIRECTION FEEDBACK MECHANISM AND MOTOR DRIVING METHOD THEREOF

(71) Applicant: ANPEC ELECTRONICS CORPORATION, HSINCHU (TW)

(72) Inventor: MING-JUNG TSAI, CHANGHUA COUNTY (TW)

(21) Appl. No.: 19/181,282

(22) Filed: Apr. 16, 2025

(30) Foreign Application Priority Data
Jan. 14, 2025 (TW) 114101400

(51) Int. Cl. H02P 6/30

(52) U.S. Cl. CPC H02P 6/30

(57) ABSTRACT

A motor driving method having a motor rotational direction feedback mechanism is performed by a motor driver. The motor driver includes a motor driving circuit, a motor state detecting circuit and a feedback circuit. The motor driver drives a motor. The motor state detecting circuit detects a rotational state of the motor. The rotational state of the motor includes a rotation direction. The feedback circuit sets at least one of a plurality of waveforms of a feedback signal according to the rotational state of the motor, and outputs the feedback signal.

### CROSS-REFERENCE TO RELATED PATENT APPLICATION

This application claims the benefit of priority to Taiwan Patent Application No. 114101400, filed on Jan. 14, 2025. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a motor, and more particularly to a motor driver having a motor rotational direction feedback mechanism and a motor driving method thereof.

### BACKGROUND OF THE DISCLOSURE

Circuit components of electronic products produce heat during operation, by which air circulating throughout an enclosed space, especially in an enclosed chassis of a server, is heated up. As a result, other circuit components can be damaged due to overheating. Therefore, fans must be disposed in the electronic products and used to cool down the circuit components of the electronic products.

When conventional motor drivers drive the motors of the fans, feedback circuits in the conventional motor drivers respectively set frequencies of feedback signals according to rotational speeds of the motors and output the feedback signals to external devices. The external devices determine the rotational speeds of the motors according to the frequencies of the feedback signals, and then manage or control the conventional motor drivers to drive the motors according to the rotational speeds of the motors.

### SUMMARY OF THE DISCLOSURE

In response to the above-referenced technical inadequacies, the present disclosure provides a motor driver having a motor rotational direction feedback mechanism. The motor driver includes a motor driving circuit, a motor state detecting circuit and a feedback circuit. The motor driving circuit is connected to a motor. The motor driving circuit is configured to drive the motor. The motor state detecting circuit is configured to detect a rotational state of the motor. The rotational state includes a rotational direction. The feedback circuit is connected to the motor state detecting circuit. The feedback circuit is configured to set at least one of a plurality of waveforms of a feedback signal, according to the rotational state of the motor. The feedback circuit is configured to output the feedback signal.

In order to solve the above-mentioned problems, one of the technical aspects adopted by the present disclosure is to provide a motor driving method having a motor rotational direction feedback mechanism. The motor driving method includes processes of: driving a motor; detecting a rotational state of the motor, in which the rotational state includes a rotational direction; and setting at least one of a plurality of waveforms of a feedback signal according to the rotational state of the motor.

As described above, the present disclosure provides the motor driver having the motor rotational direction feedback mechanism and the motor driving method thereof. In the motor driving method of the present disclosure, the motor driver of the present disclosure detects the rotational direction of the motor, sets the parameters such as the duty cycle of the plurality of waveforms of the feedback signal according to the rotational direction (including forward and reverse directions), and outputs the feedback signal. Therefore, the motor driver and the motor driving method of the present disclosure are capable of realizing notification of the rotational direction and other operational states of the motor through only the single feedback signal.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a block diagram of a motor driver having a motor rotational direction feedback mechanism according to a first embodiment of the present disclosure;

FIG. 2 is a flowchart diagram of a motor driving method having the motor rotational direction feedback mechanism according to the first embodiment of the present disclosure;

FIG. 3 is a block diagram of a motor driver having a motor rotational direction feedback mechanism according to a second embodiment of the present disclosure;

FIG. 4 is a block diagram of a motor driver having a motor rotational direction feedback mechanism according to a third embodiment of the present disclosure;

FIG. 5 is a waveform diagram of a first feedback setting signal, a reference waveform signal and a feedback signal of the motor driver having the motor rotational direction feedback mechanism according to the third embodiment of the present disclosure;

FIG. 6 is a flowchart diagram of a motor driving method having a motor rotational direction feedback mechanism according to a fourth embodiment of the present disclosure;

FIG. 7 is a schematic diagram of a forward rotational duty cycle and a reverse rotational duty cycle that are set by a motor driver having the motor rotational direction feedback mechanism according to the fourth embodiment of the present disclosure;

FIG. 8 is a flowchart diagram of a motor driving method having a motor rotational direction feedback mechanism according to a fifth embodiment of the present disclosure;

FIG. 9 is a schematic diagram of a forward rotational duty cycle range and a reverse rotational duty cycle range that are set by a motor driver having the motor rotational direction feedback mechanism according to the fifth embodiment of the present disclosure;

FIG. 10 is a flowchart diagram of a motor driving method having a motor rotational direction feedback mechanism according to a sixth embodiment of the present disclosure;

FIG. 11 is a schematic diagram of a forward rotational duty cycle and a reverse rotational duty cycle range that are set by a motor driver having the motor rotational direction feedback mechanism according to the sixth embodiment of the present disclosure;

FIG. 12 is a waveform diagram of a feedback signal that is outputted by the motor driver having the motor rotational direction feedback mechanism for braking and starting up a motor according to the sixth embodiment of the present disclosure; and

FIG. 13 is a schematic diagram of fans started up by the motor driver having the motor rotational direction feedback mechanism according to the first to sixth embodiments of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

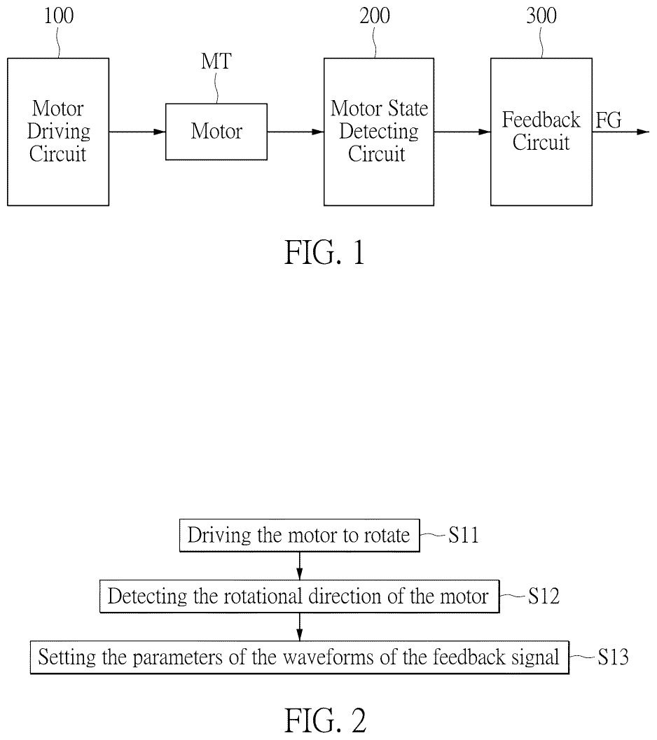

Reference is made to FIG. 1 and FIG. 2, in which FIG. 1 is a block diagram of a motor driver having a motor rotational direction feedback mechanism according to a first embodiment of the present disclosure, and FIG. 2 is a flowchart diagram of a motor driving method having the motor rotational direction feedback mechanism according to the first embodiment of the present disclosure.

The motor driver of the present disclosure includes a motor driving circuit 100, a motor state detecting circuit 200 and a feedback circuit 300. The motor driving circuit 100 is connected to a motor MT. The motor state detecting circuit 200 is disposed on the motor MT, is contacted with the motor MT or is connected to the motor MT. The feedback circuit 300 is connected to the motor state detecting circuit 200. In practice, the feedback circuit 300 may be connected to an external electronic device such as a processor and/or the motor driving circuit 100.

The motor driving method of the present disclosure includes processes S11 to S13 shown in FIG. 2. The motor driver of the present disclosure as shown in FIG. 1 performs processes S11 to S13 shown in FIG. 2.

The motor driving circuit 100 drives the motor MT (in process S11 shown in FIG. 2).

The motor state detecting circuit 200 detects a rotational state of the motor MT (in process S12 shown in FIG. 2). The rotational state of the motor MT includes a rotational direction of the motor MT.

It is worth noting that, the feedback circuit 300 sets one parameter such as a duty cycle of at least one of a plurality of waveforms of a feedback signal FG according to the rotational direction of the motor MT that is detected by the motor state detecting circuit 200 (in process S13 shown in FIG. 2). The feedback circuit 300 outputs the feedback signal FG to the external electronic device and/or the motor driving circuit 100. The motor driving circuit 100 and/or the external electronic device may drive the motor MT according to the feedback signal FG for controlling or modulating a rotational speed of the motor MT.

In addition, the motor state detecting circuit 200 detects the rotational speed of the motor MT, and the feedback circuit 300 sets another parameter such as a frequency of the at least one of the plurality of waveforms of the feedback signal FG according to the rotational speed of the motor MT that is detected by the motor state detecting circuit 200.

That is, the motor driver of the present disclosure sets the rotational direction of the motor MT to be represented by the one parameter of the at least one of the plurality of waveforms of the feedback signal FG. At the same time, the motor driver of the present disclosure sets the rotational speed of the motor MT to be represented by the another parameter of the at least one of the plurality of waveforms of the feedback signal FG. As a result, the motor driver of the present disclosure realizes notification of the rotational direction and the rotational speed of the motor MT through only the feedback signal FG.

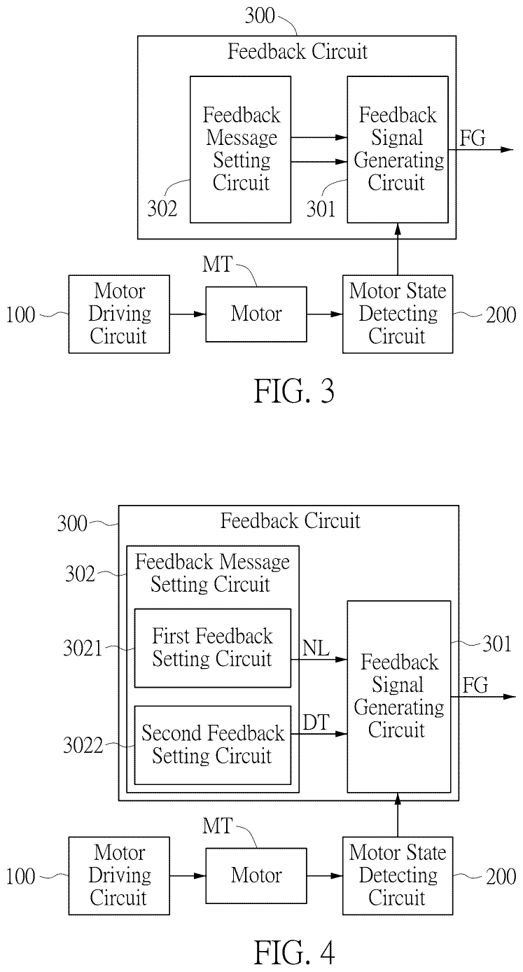

Reference is made to FIG. 3, which is a block diagram of a motor driver having a motor rotational direction feedback mechanism according to a second embodiment of the present disclosure.

As shown in FIG. 3, in the second embodiment, the motor driver of the present disclosure includes the motor driving circuit 100, the motor state detecting circuit 200 and the feedback circuit 300. The feedback circuit 300 includes a feedback signal generating circuit 301 and a feedback message setting circuit 302. The feedback signal generating circuit 301 is connected to the feedback message setting circuit 302 and the motor state detecting circuit 200. The motor state detecting circuit 200 is disposed on the motor MT, is contacted with the motor MT or is connected to the motor MT.

The feedback message setting circuit 302 sets a plurality of feedback setting signals.

The feedback signal generating circuit 301, according to the rotational state (including the rotational direction) of the motor MT, selects one of the plurality of feedback setting signals from the feedback message setting circuit 302. The feedback signal generating circuit 301 generates the feedback signal FG based on the one of the plurality of feedback setting signals. The feedback signal generating circuit 301 outputs the feedback signal FG to the external electronic device and/or the motor driving circuit 100.

For example, the feedback message setting circuit 302 sets the plurality of feedback setting signals to respectively correspond to a plurality of specific rotational directions, and sets the plurality of feedback setting signals to respectively include a plurality of specific parameters (such as a plurality of reference duties). The plurality of specific rotational directions are respectively represented by the plurality of specific parameters (such as the plurality of reference duties). For example, the specific parameter (such as the reference duty cycle) included in each one of the plurality of feedback setting signals may be a parameter (such as a duty cycle) of each of a plurality of waveforms of the one of the plurality of feedback setting signals. The feedback signal generating circuit 301 obtains one of the plurality of feedback setting signals that corresponds to the specific rotational direction being equal to the rotational direction of the motor MT. The feedback signal generating circuit 301 sets the parameter (such as the duty cycle) of at least one of the plurality of waveforms of the feedback signal FG to be equal to the specific parameter (such as the reference duty cycle) of the one of the plurality of feedback setting signals.

It is worth noting that, the feedback message setting circuit 302 may, according to the plurality of feedback setting signals from the external electronic device of a receiving terminal (such as a client), set or modulate the plurality of specific parameters (such as the plurality of reference duties) that respectively represent the plurality of specific rotational directions. The feedback message setting circuit 302 may receive the specific parameters having different values that represent the same specific rotational direction respectively from a plurality of receiving terminals (such as a plurality of clients). Therefore, when the motor MT rotates along the same rotational direction, the external electronic devices of the plurality of receiving terminals (such as the plurality of clients) respectively receive the plurality of feedback signals FG, and the duty cycles of the plurality of waveforms of each one of the plurality of feedback signals FG are different from the duty cycles of another of the plurality of feedback signals FG.

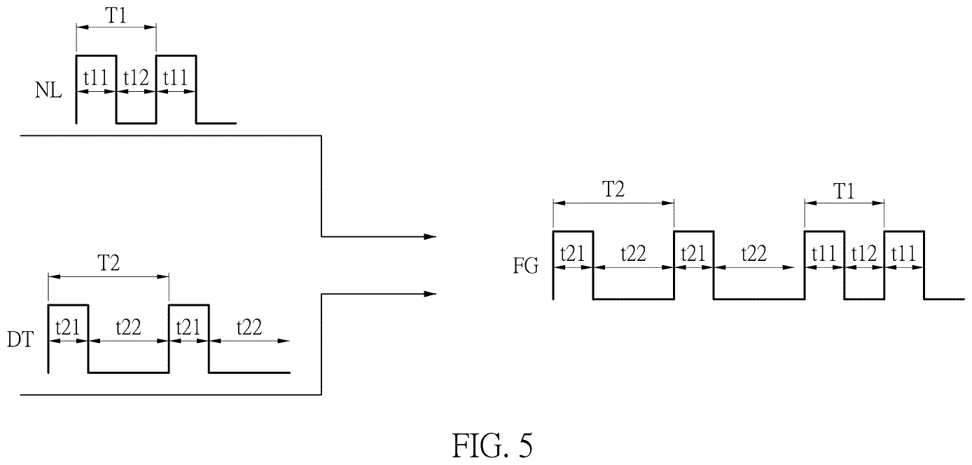

Reference is made to FIG. 4 and FIG. 5, in which FIG. 4 is a block diagram of a motor driver having a motor rotational direction feedback mechanism according to a third embodiment of the present disclosure, and FIG. 5 is a waveform diagram of a first feedback setting signal, a reference waveform signal and a feedback signal of the motor driver having the motor rotational direction feedback mechanism according to the third embodiment of the present disclosure.

As shown in FIG. 4, in the third embodiment, the motor driver of the present disclosure includes the motor driving circuit 100, the motor state detecting circuit 200 and the feedback circuit 300. The feedback circuit 300 includes the feedback signal generating circuit 301 and the feedback message setting circuit 302. The feedback message setting circuit 302 includes a first feedback setting circuit 3021 and a second feedback setting circuit 3022. The feedback signal generating circuit 301 is connected to the second feedback setting circuit 3022, the first feedback setting circuit 3021 and the motor state detecting circuit 200.

The first feedback setting circuit 3021 sets a first feedback setting signal NL and outputs the first feedback setting signal NL to the feedback signal generating circuit 301. The second feedback setting circuit 3022 sets a second feedback setting signal DT and outputs the second feedback setting signal DT to the feedback signal generating circuit 301. The plurality of feedback setting signals described above may include the first feedback setting signal NL and the second feedback setting signal DT.

For example, when the rotational direction of the motor MT that is detected by the motor state detecting circuit 200 is the same as the specific forward direction, the feedback signal generating circuit 301 does not modulate duty cycles of a plurality of waveforms of the first feedback setting signal NL. At this time, the duty cycles of the plurality of waveforms of the feedback signal FG are equal to the duty cycles of the plurality of waveforms of the first feedback setting signal NL.

Conversely, when the rotational direction of the motor MT that is detected by the motor state detecting circuit 200 is different from the specific forward direction or is the same as the specific reverse direction, the feedback signal generating circuit 301 may modulate the duty cycles of the plurality of waveforms of the first feedback setting signal NL to be equal to duty cycles of a plurality of waveforms of the second feedback setting signal DT. The feedback signal generating circuit 301 may output the feedback signal FG including the plurality of waveforms that are modulated.

Alternatively, when the rotational direction of the motor MT that is detected by the motor state detecting circuit 200 is different from the specific forward direction or is the same as the specific reverse direction, the feedback signal generating circuit 301 may directly set the duty cycles of the plurality of waveforms of the feedback signal FG to be equal to the duty cycles of the plurality of waveforms of the second feedback setting signal DT.

Therefore, when the rotational direction of the motor MT is switched between the specific forward direction and the specific reverse direction, the duty cycles of some of the plurality of waveforms of the feedback signal FG outputted by the feedback signal generating circuit 301 are equal to the duty cycles of one or more of the plurality of waveforms of the second feedback setting signal DT, and the duty cycles of others of the plurality of waveforms of the feedback signal FG are equal to the duty cycles of one or more of the plurality of waveforms of the first feedback setting signal NL.

For example, when the rotational direction of the motor MT is switched from the specific reverse direction to the specific forward direction, the feedback signal generating circuit 301 may output the feedback signal FG shown in FIG. 5. As shown in FIG. 5, the duty cycles of a first one and a second one of the plurality of waveforms of the feedback signal FG are equal to the duty cycles of the plurality of waveforms of the second feedback setting signal DT, and the duty cycles of a third one and a fourth one of the plurality of waveforms of the feedback signal FG are equal to the duty cycles of the plurality of waveforms of the first feedback setting signal NL.

A ratio of a working period t21 of the first one of the plurality of waveforms of the feedback signal FG to an entire period T2 of the first one of the plurality of waveforms of the feedback signal FG is the duty cycle of the first one of the plurality of waveforms of the feedback signal FG. The entire period T2 of the first one of the plurality of waveforms of the feedback signal FG is a sum of the working period t21 and a non-working period t22 of the first one of the plurality of waveforms of the feedback signal FG. The feedback signal FG is at a high level during the working period t21. The feedback signal FG is at a low level during the non-working period t22.

Similarly, the ratio of the working period t21 of the second one of the plurality of waveforms of the feedback signal FG to the entire period T2 of the second one of the plurality of waveforms of the feedback signal FG is the duty cycle of the second one of the plurality of waveforms of the feedback signal FG. The entire period T2 of the second one of the plurality of waveforms of the feedback signal FG is the sum of the working period t21 and the non-working period t22 of the second one of the plurality of waveforms of the feedback signal FG.

A ratio of a working period t11 of the third one of the plurality of waveforms of the feedback signal FG to an entire period T1 of the third one of the plurality of waveforms of the feedback signal FG is the duty cycle of the third one of the plurality of waveforms of the feedback signal FG. The entire period T1 of the third one of the plurality of waveforms of the feedback signal FG is a sum of the working period t11 and a non-working period t12 of the third one of the plurality of waveforms of the feedback signal FG. The feedback signal FG is at the high level during the working period t11. The feedback signal FG is at the low level during the non-working period t12.

Similarly, the ratio of the working period t11 of the fourth one of the plurality of waveforms of the feedback signal FG to the entire period T1 of the fourth one of the plurality of waveforms of the feedback signal FG is the duty cycle of the fourth one of the plurality of waveforms of the feedback signal FG. The entire period T1 of the fourth one of the plurality of waveforms of the feedback signal FG is the sum of the working period t11 and the non-working period t12 of the fourth one of the plurality of waveforms of the feedback signal FG.

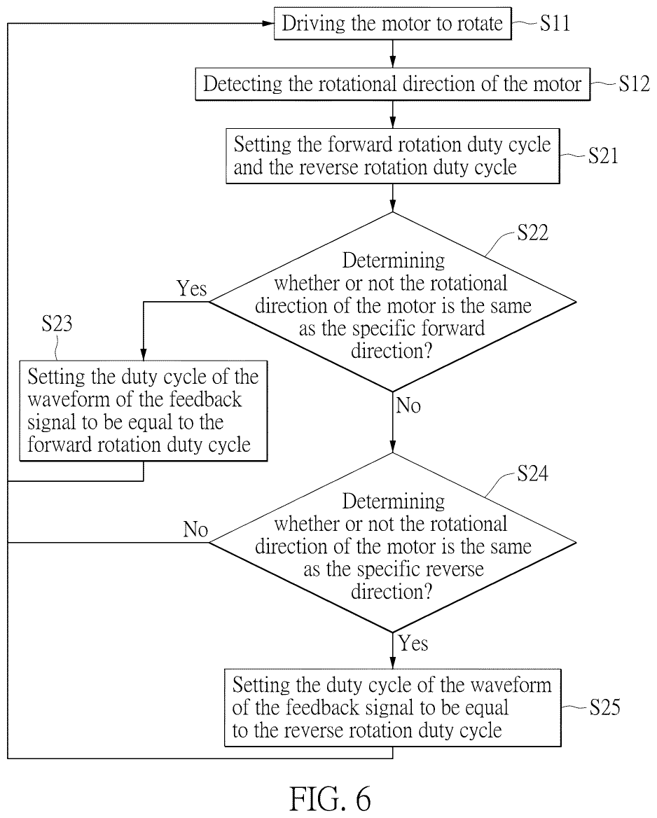

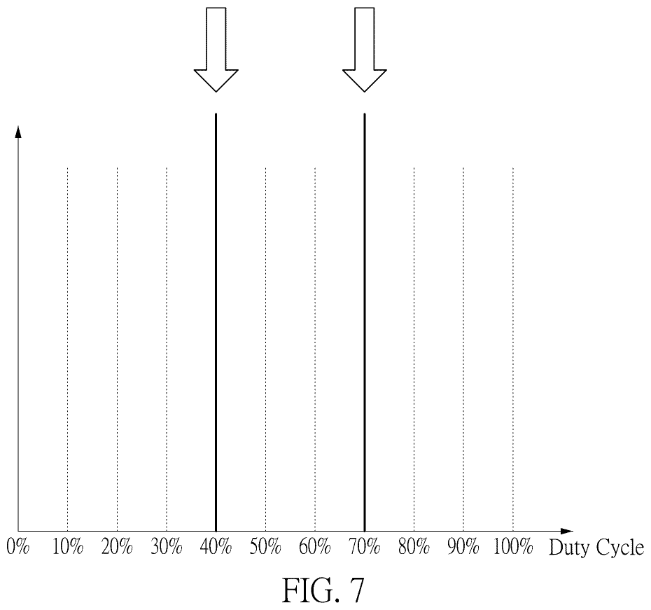

Reference is made to FIG. 6 and FIG. 7, in which FIG. 6 is a flowchart diagram of a motor driving method having a motor rotational direction feedback mechanism according to a fourth embodiment of the present disclosure, and FIG. 7 is a schematic diagram of a forward rotational duty cycle and a reverse rotational duty cycle that are set by a motor driver having the motor rotational direction feedback mechanism according to the fourth embodiment of the present disclosure.

The motor driving method of the present disclosure includes processes S21 to S25 shown in FIG. 6. The motor driver of the present disclosure as shown in FIG. 1, FIG. 3 and FIG. 4 performs processes S21 to S25 shown in FIG. 6. Processes S21 to S25 shown in FIG. 6 may be included in process S13 shown in FIG. 2, and may be performed after processes S11 and S12 are performed. For convenience of explanation, in the fourth embodiment, processes S21 to S25 shown in FIG. 6 are performed by the motor driver of the present disclosure as shown in FIG. 4.

The first feedback setting circuit 3021 sets the duty cycle of each of the plurality of waveforms of the first feedback setting signal NL representing the specific forward direction as a forward rotation duty cycle (in process S21 shown in FIG. 6).

The second feedback setting circuit 3022 sets the duty cycle of each of the plurality of waveforms of the second feedback setting signal DT representing the specific reverse direction as a reverse rotation duty cycle (in process S21 shown in FIG. 6).

The feedback signal generating circuit 301 determines whether or not the rotational direction of the motor MT that is detected by the motor state detecting circuit 200 is the same as the specific forward direction (in process S22 shown in FIG. 6).

When the rotational direction of the motor MT is the same as the specific forward direction, the feedback signal generating circuit 301 sets or modulates the duty cycle of each of the plurality of waveforms of the feedback signal FG to be equal to the forward rotation duty cycle (in process S23 shown in FIG. 6).

Conversely, when the rotational direction of the motor MT is different from the specific forward direction, the feedback signal generating circuit 301 determines whether or not the rotational direction of the motor MT is the same as the specific reverse direction (in process S24 shown in FIG. 6).

When the rotational direction of the motor MT is the same as the specific reverse direction, the feedback signal generating circuit 301 sets or modulates the duty cycle of each of the plurality of waveforms of the feedback signal FG to be equal to the reverse rotation duty cycle (in process S25 shown in FIG. 6).

For example, as shown in FIG. 7, the forward rotation duty cycle may be 40% and the reverse rotation duty cycle may be 70%. Alternatively, the forward rotation duty cycle may be 70% and the reverse rotation duty cycle may be 40%.

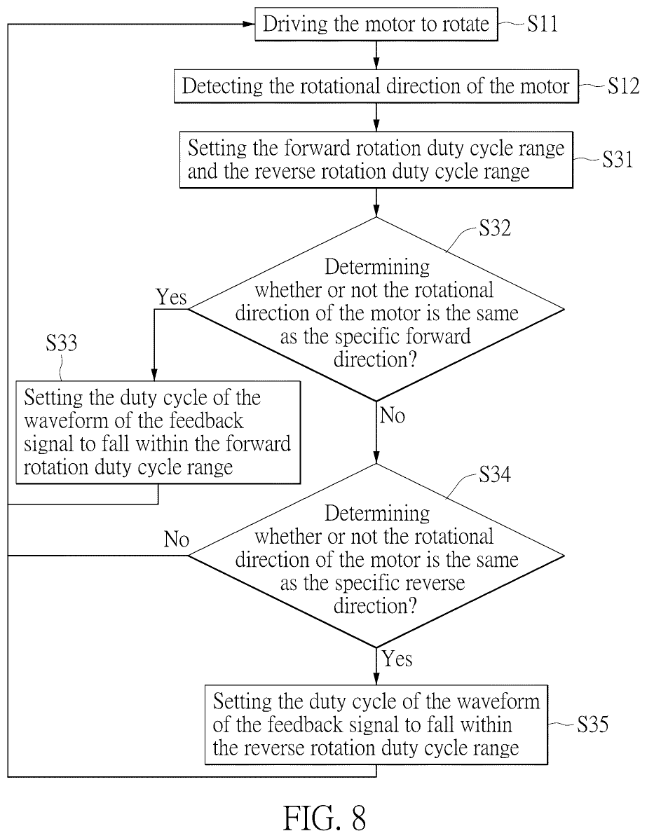

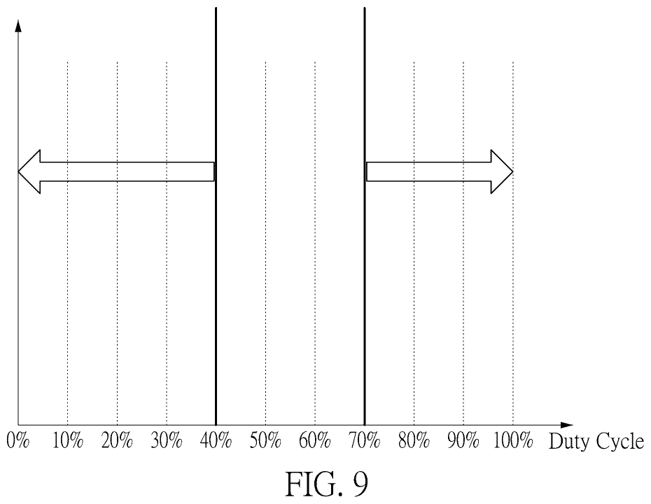

Reference is made to FIG. 8 and FIG. 9, in which FIG. 8 is a flowchart diagram of a motor driving method having a motor rotational direction feedback mechanism according to a fifth embodiment of the present disclosure, and FIG. 9 is a schematic diagram of a forward rotational duty cycle range and a reverse rotational duty cycle range that are set by a motor driver having the motor rotational direction feedback mechanism according to the fifth embodiment of the present disclosure.

The motor driving method of the present disclosure includes processes S31 to S35 shown in FIG. 8. The motor driver of the present disclosure as shown in FIG. 1, FIG. 3 and FIG. 4 performs processes S31 to S35 shown in FIG. 8. Processes S31 to S35 may be included in process S13 shown in FIG. 2, and may be performed after processes S11 and S12 shown in FIG. 2 are performed. For convenience of explanation, in the fifth embodiment, processes S31 to S35 shown in FIG. 8 are performed by the motor driver of the present disclosure as shown in FIG. 4.

The first feedback setting circuit 3021 sets the first feedback setting signal NL to include a forward rotation duty cycle range (in process S31 shown in FIG. 8).

The second feedback setting circuit 3022 sets the second feedback setting signal DT to include a reverse rotation duty cycle range (in process S31 shown in FIG. 8).

The feedback signal generating circuit 301 determines whether or not the rotational direction of the motor MT that is detected by the motor state detecting circuit 200 is the same as the specific forward direction (in process S32 shown in FIG. 8).

When the rotational direction of the motor MT is the same as the specific forward direction, the feedback signal generating circuit 301 sets or modulates the duty cycle of at least one of the plurality of waveforms of the feedback signal FG to fall within the forward rotation duty cycle range (in process S33 shown in FIG. 8).

Conversely, when the rotational direction of the motor MT is not the same as the specific forward direction, the feedback signal generating circuit 301 determines whether or not the rotational direction of the motor MT that is detected by the motor state detecting circuit 200 is the same as the specific reverse direction (in process S34 shown in FIG. 8).

When the rotational direction of the motor MT is the same as the specific reverse direction, the feedback signal generating circuit 301 sets or modulates the duty cycle of at least one of the plurality of waveforms of the feedback signal FG to fall within the reverse rotation duty cycle range (in process S35 shown in FIG. 8).

For example, as shown in FIG. 9, the forward rotation duty cycle range may be a range being smaller than (or equal to) 40%, and the reverse rotation duty cycle range may be a range being larger than (or equal to) 70%. Alternatively, the forward rotation duty cycle range may be a range being larger than (or equal to) 70%, and the reverse rotation duty cycle range may be a range being smaller than (or equal to) 40%.

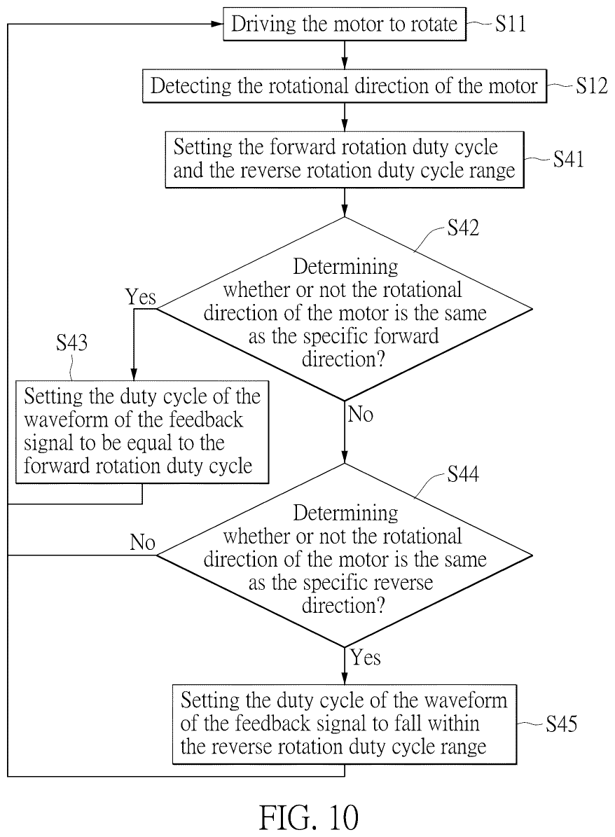

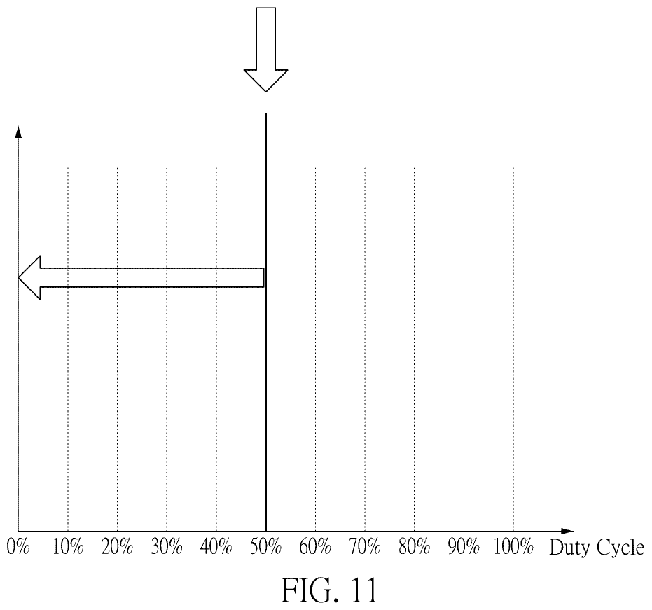

Reference is made to FIG. 10 and FIG. 11, in which FIG. 10 is a flowchart diagram of a motor driving method having a motor rotational direction feedback mechanism according to a sixth embodiment of the present disclosure, and FIG. 11 is a schematic diagram of a forward rotational duty cycle and a reverse rotational duty cycle range that are set by a motor driver having the motor rotational direction feedback mechanism according to the sixth embodiment of the present disclosure.

The motor driving method of the present disclosure includes processes S41 to S45 shown in FIG. 10. The motor driver of the present disclosure as shown in FIG. 1, FIG. 3 and FIG. 4 performs processes S41 to S45 shown in FIG. 10. Processes S41 to S45 shown in FIG. 10 may be included in process S13 shown in FIG. 2, and may be performed after processes S11 and S12 are performed. For convenience of explanation, in the sixth embodiment, processes S41 to S45 shown in FIG. 10 are performed by the motor driver of the present disclosure as shown in FIG. 4.

The first feedback setting circuit 3021 sets the first feedback setting signal NL to include the forward rotation duty cycle as a specific duty cycle (in process S41 shown in FIG. 10). In practice, the first feedback setting circuit 3021 may set the first feedback setting signal NL to include a forward rotation waveform signal, and a duty cycle of each of a plurality of waveforms of the forward rotation waveform signal is equal to the forward rotation duty cycle.

The second feedback setting circuit 3022 sets the second feedback setting signal DT to include the reverse rotation duty cycle range as a specific duty cycle range (in process S41 shown in FIG. 10).

The feedback signal generating circuit 301 determines whether or not the rotational direction of the motor MT that is detected by the motor state detecting circuit 200 is the same as the specific forward direction (in process S42 shown in FIG. 10).

When the rotational direction of the motor MT is the same as a first rotational direction such as the specific forward direction, the feedback signal generating circuit 301 sets or modulates the duty cycle of at least one of the plurality of waveforms of the feedback signal FG to be equal to the forward rotation duty cycle (in process S43 shown in FIG. 10).

Conversely, when the rotational direction of the motor MT is not the same as the specific forward direction, the feedback signal generating circuit 301 determines whether or not the rotational direction of the motor MT that is detected by the motor state detecting circuit 200 is the same as the specific reverse direction (in process S44 shown in FIG. 10).

When the rotational direction of the motor MT is the same as a second rotational direction such as the specific reverse direction, the feedback signal generating circuit 301 sets or modulates the duty cycle of at least one of the plurality of waveforms of the feedback signal FG to fall within the reverse rotation duty cycle range (in process S45 shown in FIG. 10).

For example, as shown in FIG. 9, the forward rotation duty cycle may be equal to 50%, and the reverse rotation duty cycle range may be a range being smaller than (or larger than) 50%. Alternatively, the forward rotation duty cycle may be a range being smaller than (or larger than) 50%, and the reverse rotation duty cycle range may be equal to 50%.

In practice, the first feedback setting circuit 3021 may set the first feedback setting signal NL to include the forward rotation duty cycle range and may set the second feedback setting signal DT to include the reverse rotation duty cycle.

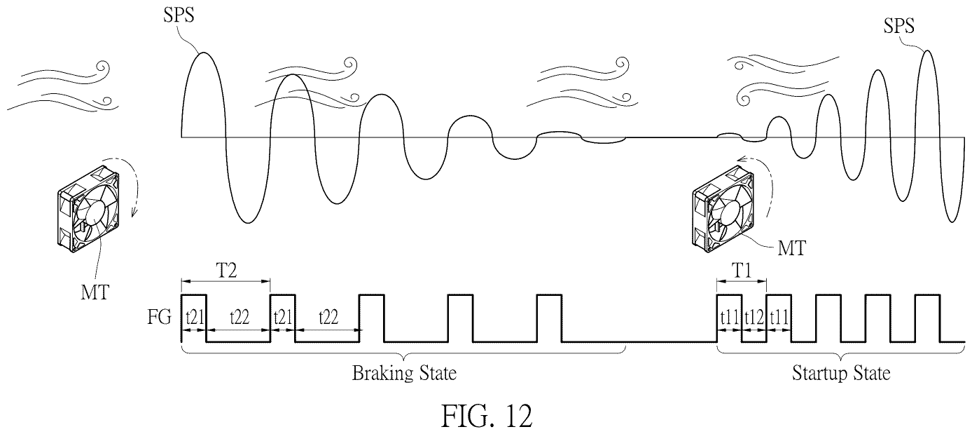

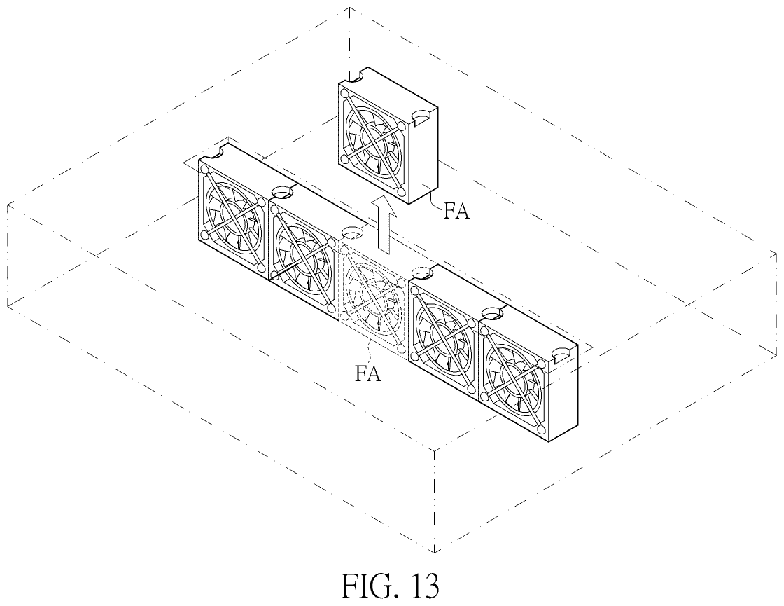

Reference is made to FIG. 12 and FIG. 13, in which FIG. 12 is a waveform diagram of a feedback signal that is outputted by the motor driver having the motor rotational direction feedback mechanism for braking and starting up a motor according to the sixth embodiment of the present disclosure, and FIG. 13 is a schematic diagram of fans started up by the motor driver having the motor rotational direction feedback mechanism according to the first to sixth embodiments of the present disclosure.

As shown in FIG. 13, a plurality of fans FA are arranged in a same row inside an electronic device. Each of the plurality of fans FA includes the motor MT described above. The motor driver of the present disclosure performs the motor driving method of the present disclosure on the motor MT of each of the plurality of fans FA.

When any one of the plurality of fans FA is damaged inside the electronic device and is removed out from the electronic device as shown in FIG. 13, air flows to accommodation spaces where the plurality of fans FA are accommodated. As a result, when a new fan is disposed in an accommodation space from which the damaged fan FA is removed to replace the damaged fan FA, the new fan rotates along a reverse direction.

Therefore, when the damaged fan FA is removed out from the electronic device, the motor driver of the present disclosure brakes the motor MT of each of the plurality of fans FA, thereby preventing the new fan from rotating along the reverse direction. As a result, the new fan can rotate normally.

When the motor driver of the present disclosure brakes the motor MT of each of the plurality of fans FA, the motor driving circuit 100 of the motor driver of the present disclosure drives the motor MT of each of the plurality of fans FA to rotate along the specific reverse direction. As a result, as shown in FIG. 12, amplitudes of a plurality of waveforms of a motor speed signal SPS are gradually reduced, which represents that the rotational speed of the motor MT of each of the plurality of fans FA is gradually reduced. At this time, the feedback signal generating circuit 301 shown in FIG. 4 outputs some of the plurality of waveforms of the feedback signal FG shown in FIG. 12, and the duty cycles of the some of the waveforms of the feedback signal FG are equal to the duty cycles of the plurality of waveforms of the second feedback setting signal DT shown in FIG. 5.

After the motor MT is braked, the motor driver of the present disclosure starts up the fans FA that are not damaged and the new fan FA in the electronic device. When the motor driver of the present disclosure starts up the motors MT of the fans FA and the new fan, the motor driving circuit 100 of the motor driver of the present disclosure drives the motors MT of the fans FA and the new fan to rotate along the specific forward direction. As a result, as shown in FIG. 12, the amplitudes of the plurality of waveforms of the motor speed signal SPS are gradually increased, which represents that the rotational speed of the motor MT of each of the plurality of fans FA is gradually increased. At this time, the feedback signal generating circuit 301 shown in FIG. 4 outputs others of the plurality of waveforms of the feedback signal FG shown in FIG. 12, and the duty cycles of the others of the plurality of waveforms of the feedback signal FG are equal to the duty cycles of the plurality of waveforms of the first feedback setting signal NL shown in FIG. 5.

In conclusion, the present disclosure provides the motor driver having the motor rotational direction feedback mechanism and the motor driving method thereof. In the motor driving method of the present disclosure, the motor driver of the present disclosure detects the rotational direction of the motor, sets the parameters such as the duty cycle of the plurality of waveforms of the feedback signal according to the detected rotational direction (including forward and reverse directions), and outputs the feedback signal. Therefore, the motor driver and the motor driving method of the present disclosure are capable of realizing the notification of the rotational direction and other operational states of the motor through only the single feedback signal.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A motor driver having a motor rotational direction feedback mechanism, comprising:
a motor driving circuit connected to a motor, and configured to drive the motor;
a motor state detecting circuit configured to detect a rotational state of the motor, wherein the rotational state includes a rotational direction; and
a feedback circuit connected to the motor state detecting circuit, and configured to set at least one of a plurality of waveforms of a feedback signal according to the rotational state of the motor and output the feedback signal.

2. The motor driver according to claim 1, wherein the feedback circuit is configured to set a forward rotation duty cycle and a reverse rotation duty cycle;
wherein, when the rotational direction of the motor is the same as a specific forward direction, the feedback circuit sets a duty cycle of the at least one of the plurality of waveforms of the feedback signal to be equal to the forward rotation duty cycle;
wherein, when the rotational direction of the motor is the same as a specific reverse direction, the feedback circuit sets the duty cycle of the at least one of the plurality of waveforms of the feedback signal to be equal to the reverse rotation duty cycle.

3. The motor driver according to claim 1, wherein the feedback circuit is configured to set a forward rotation duty cycle range and a reverse rotation duty cycle range;
wherein, when the rotational direction of the motor is the same as a specific forward direction, the feedback circuit sets a duty cycle of the at least one of the plurality of waveforms of the feedback signal to fall within the forward rotation duty cycle range;
wherein, when the rotational direction of the motor is the same as a specific reverse direction, the feedback circuit sets the duty cycle of the at least one of the plurality of waveforms of the feedback signal to fall within the reverse rotation duty cycle range.

4. The motor driver according to claim 1, wherein the feedback circuit is configured to set a specific duty cycle and a specific duty cycle range;
wherein, when the rotational direction of the motor is the same as a first rotational direction, the feedback circuit sets a duty cycle of the at least one of the plurality of waveforms of the feedback signal to be equal to the specific duty cycle;
wherein, when the rotational direction of the motor is the same as a second rotational direction, the feedback circuit sets the duty cycle of the at least one of the plurality of waveforms of the feedback signal to fall within the specific duty cycle range.

5. The motor driver according to claim 1, wherein the feedback circuit includes:
a feedback message setting circuit configured to output a plurality of feedback setting signals; and
a feedback signal generating circuit connected to the feedback message setting circuit and the motor state detecting circuit, configured to select one of the plurality of feedback setting signals according to the rotational direction of the motor, and configured to output the feedback signal based on the feedback setting signal that is selected.

6. The motor driver according to claim 5, wherein the feedback message setting circuit includes:
a first feedback setting circuit connected to the feedback signal generating circuit, and configured to output a first feedback setting signal; and
a second feedback setting circuit connected to the feedback signal generating circuit, and configured to output a second feedback setting signal;
wherein the plurality of feedback setting signals includes the first feedback setting signal and the second feedback setting signal;
wherein, when the rotational direction of the motor is the same as a specific reverse direction, the feedback signal generating circuit modulates one or more waveforms of the first feedback setting signal according to the second feedback setting signal, and outputs the feedback signal including the one or more waveforms that are modulated.

7. A motor driving method having a motor rotational direction feedback mechanism, comprising processes of:
driving a motor;
detecting a rotational state of the motor, wherein the rotational state includes a rotational direction; and
setting at least one of a plurality of waveforms of a feedback signal according to the rotational state of the motor.

8. The motor driving method according to claim 7, further comprising processes of:
setting a forward rotation duty cycle and a reverse rotation duty cycle;
when the rotational direction of the motor is the same as a specific forward direction, setting a duty cycle of the at least one of the plurality of waveforms of the feedback signal to be equal to the forward rotation duty cycle; and
when the rotational direction of the motor is the same as a specific reverse direction, setting the duty cycle of the at least one of the plurality of waveforms of the feedback signal to be equal to the reverse rotation duty cycle.

9. The motor driving method according to claim 7, further comprising processes of:
setting a forward rotation duty cycle range and a reverse rotation duty cycle range;
when the rotational direction of the motor is the same as a specific forward direction, setting a duty cycle of the at least one of the plurality of waveforms of the feedback signal to fall within the forward rotation duty cycle range; and
when the rotational direction of the motor is the same as a specific reverse direction, setting the duty cycle of the at least one of the plurality of waveforms of the feedback signal to fall within the reverse rotation duty cycle range.

10. The motor driving method according to claim 7, further comprising processes of:
setting a specific duty cycle and a specific duty cycle range;
when the rotational direction of the motor is the same as a first rotational direction, setting a duty cycle of the at least one of the plurality of waveforms of the feedback signal to be equal to the specific duty cycle; and
when the rotational direction of the motor is the same as a second rotational direction, setting the duty cycle of the at least one of the plurality of waveforms of the feedback signal to fall within the specific duty cycle range.

11. The motor driving method according to claim 7, further comprising processes of:
generating a plurality of feedback setting signals; and
selecting one of the plurality of feedback setting signals according to the rotational direction of the motor and outputting the feedback signal based on the one of the plurality of feedback setting signals.

12. The motor driving method according to claim 7, further comprising processes of:
generating a first feedback setting signal;
generating a second feedback setting signal; and
determining whether or not the rotational direction of the motor is the same as a specific reverse direction, in response to determining that the rotational direction of the motor is the same as the specific reverse direction, modulating one or more waveforms of the first feedback setting signal according to the second feedback setting signal and outputting the feedback signal including the one or more waveforms that are modulated, and in response to determining that the rotational direction of the motor is not the same as the specific reverse direction, outputting the first feedback setting signal as the feedback signal.
